(19) United States
(12) Patent Application Publication
(10) Pub. No.: US 2005/0190731 A1
(43) Pub. Date: Sep. 1, 2005

(54) Methods and devices for providing a relative level of fairness and QoS guarantees to wireless local area networks

(76) Inventors: Yigal Bejerano, Springfield, NJ (US); Randeep S. Bhatia, Green Brook, NJ (US)

Correspondence Address: HARNESS, DICKEY & PIERCE, P.L.C., P.O. Box 8910, Reston, VA, 20195, US

(21) Appl. No.: 10/788,460

(22) Filed: Mar. 1, 2004

(51) Int. Cl. H04Q 7/00

(52) U.S. Cl. 370/338; 370/447

(57) ABSTRACT

Problems associated with hidden nodes and overlapping cells in Wireless Local Area Networks (WLANs) are substantially eliminated by only allowing non-interfering Access Points to transmit during assigned slots of a contention-free period (CFP). The CFP is broken up into a number of slots which are assigned to Access Points based on the number of users associated with each Access Point. This assures a relative level of fairness and a quality of service.

### BACKGROUND OF THE INVENTION

In recent years there has been a tremendous rise in the development of IEEE 802.11 based, wireless local area networks (“WLANs”). To be successful, however, some shortcomings of WLANs must be overcome. Two of these shortcomings include the failure to ensure fairness (i.e., a minimal allocated bandwidth) and to provide quality of service (“QoS”) guarantees. Without the latter, WLANs are incapable of supporting real-time (“RT”) services such as voice and video conferencing.

Generally speaking, fairness relates to a network's ability to provide the same level of service to all of its users. That said, “fairness” is a relative term. What amounts to fairness for one network may not be seen as fairness in another. That is, fairness is network dependent.

QoS guarantees relate to a network's ability to provide a service with some level of data delivery assurance. This assurance is usually given in terms of guaranteed bandwidth, delay bounds or jitter—parameters which are important in RT applications.

QoS guarantees and fairness are interrelated. A network that cannot provide a certain degree of fairness cannot provide a QoS guarantee.

Complicating matters, the current IEEE 802.11 Medium Access Control (MAC) standard does not include requirements that provide for both fairness and QoS guarantees.

The IEEE 802.11 MAC standard defines two modes of operation. The first is a “best effort”, Distributed Coordination Function (“DCF”) that employs a Carrier Sense Multiple Access/Collision Avoidance scheme. In this mode, users (i.e., their WLAN compatible devices) compete for the opportunity to transmit data during a so-called contention period (“CP”). The DCF mode is known to exhibit both short and long-term unfairness because its MAC layer may fail to equitably allocate channel resources to competing wireless devices (e.g., it doesn't give users a fair amount of time to transmit data).

The second mode of operation is referred to as a Point Coordination Function (“PCF”) mode which is designed to support RT traffic. In PCF mode, a network access-point (“AP”) periodically initiates contention free periods (“CFPs”) during which it polls associated wireless devices in a round-robin manner to provide service. Unlike the DCF mode, the PCF mode allows a network to provide bandwidth and delay guarantees, necessary to support RT applications.

Up to now, PCF mode applications have only been considered for networks having a single access point, where it is assumed that each user is in the transmission cell range (i.e., of the access point). However, this assumption does not apply in networks that include multiple access points with overlapping transmission ranges. In such networks, transmission collisions may occur during a CFP due to so-called “hidden nodes” that have not received beacon messages announcing the beginning of a CFP (the so-called hidden node problem) or when two adjacent access points schedule their CFPs simultaneously (known as the overlapping cell problem). Thus, a wireless device may fail to send or receive data when polled during a CFP due to interference from other transmission cells. In fact, during simulations carried out by the present inventors, it was discovered that the service level that a mobile user experiences drastically decreases as its distance from its associated access point is increased because of interference from adjacent transmission cells, especially for users near a transmission cell boundary (i.e., practically speaking, they do not receive any service, both in the DCF and PCF mode).

Recently, there has been some work to address the overlapping transmission cell problem using distributed time synchronization algorithms and game theory methods. However, these schemes cannot ensure either fairness or QoS guarantees. Currently, an IEEE 802.11 committee is finishing a new proposal aimed at adding QoS assurance capabilities to the existing standard (the so-called IEEE 802.1 1-e proposal). However, even this proposal does not provide an adequate solution to overcome either the hidden node or overlapping cell problem.

### SUMMARY OF THE INVENTION

The present invention provides for methods and devices which advantageously overcome both the hidden node and overlapping cell problem in multiple-AP, WLAN networks. During a CFP, time is divided into slots such that within each slot only a non-interfering group of APs are allowed to transmit to their respective users. By ensuring that the APs activated in any slot of a CFP are non-interfering, the present invention avoids the overlapping cell and hidden node problems. Further, the present invention also ensures a relative level of fairness and provides for QoS guarantees by assigning one or more slots of the CFP to an AP based on the number of users associated with each AP.

### BRIEF DESCRIPTION OF THE DRAWINGS

FIG. 1 depicts a simplified drawing of a WLAN network according to embodiments of the present invention.

FIG. 2 depicts a CFP divided into slots according to one embodiment of the present invention.

FIG. 3 depicts one example of an interference graph which includes six APs according to one embodiment of the present invention.

FIG. 4 depicts a CFP, associated with the interference graph and APs in FIG. 3, divided into slots and illustrating some details of the use of beacon message signals according to one embodiment of the present invention.

### DETAILED DESCRIPTION OF THE INVENTION

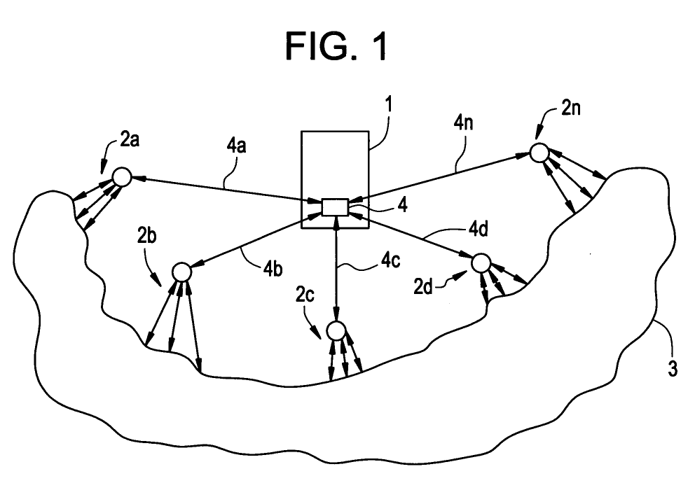

Referring to FIG. 1, there is shown a network operation center (“NOC”) 1 for coordinating APs 2a, . . . 2n (where “n” is the last AP). For present purposes, it is assumed that the internal clocks of the NOC 1 and APs 2a, . . . 2n are synchronized. Each AP is programmed with software used to control the provisioning of QoS guarantees and bandwidth fairness to associated users 3 and to communicate with the NOC 1. The present invention does not require any modification of the IEEE 802.11 standard or to software used by mobile users. Rather, modifications (to software, firmware or hardware) need only be made to NOC 1 or APs 2a, . . . 2n. It is assumed that mobile users 3 are able to convey, via request messages, the type of session they wish to initiate (e.g., an RT or Non-RT (“NRT”) session).

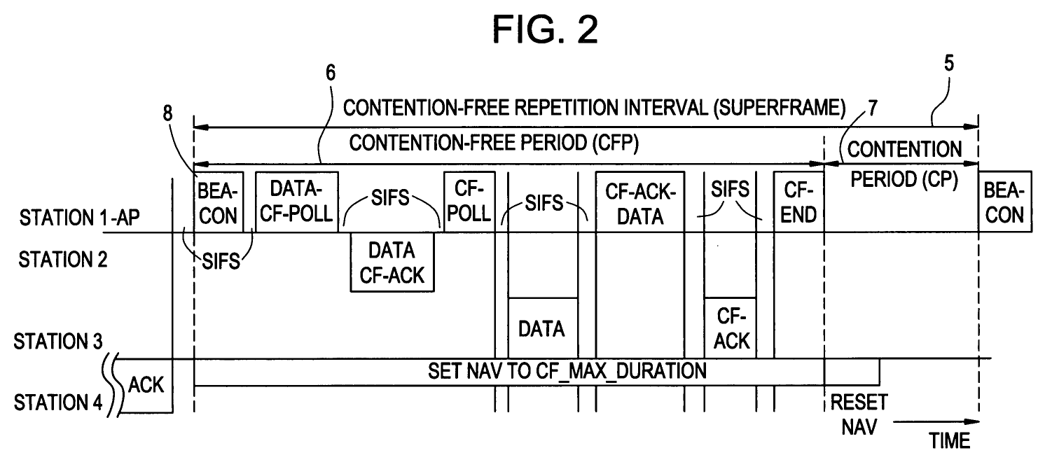

Referring now to FIG. 2, there is shown an example of a superframe 5 which comprises a CFP 6 and a CP 7. In one embodiment of the present invention, during slot's of the CFP 6 certain access points and their associated users are allowed to transmit both RT and NRT data in a way that ensures inter-AP fairness and QoS levels. In contrast, the CP is utilized to serve users of APs 2a, . . . 2n and as a signaling channel for initiating new data sessions and exchanging management-related messages.

The present invention overcomes the overlapping cell problem as follows. In one embodiment of the present invention, the CFP 6 is divided into slots, each slot having a size which is at least Δ time units, for a specified parameter Δ. For example, the NOC 1 may comprise a central controller 4 operable to assign slots to the APs 2a, . . . 2n such that no two APs 2a, . . . 2n, whose transmission may interfere, are given the same slot. Said another way, only non-interfering APs are allowed to transmit during the same slot.

In a further embodiment of the present invention, the APs assigned to a given slot cease transmitting at the end of the slot, thus avoiding collisions with transmissions in following slots of the CFP. In this manner, the present invention overcomes the overlapping cell problem inherent in existing techniques and systems.

It should be understood that the controller 4 determines the slot assignments for each of the APs 2a, . . . 2n and synchronizes each of the APs 2a, . . . 2n. However, it is left up to each AP 2a, . . . 2n to manage its own admission control mechanism for accepting new RT data sessions and to determine its own order for polling associated users 3.

Having presented a general overview of how the present invention solves the overlapping cell problem, the following provides a more detailed discussion.

To begin, every AP is associated with a set of wireless devices (i.e., users) which it may communicate with within a certain transmission range. At the same time a first AP is communicating with one of its associated users, a second AP may interfere with such communications if the second AP is within an interference range of the first AP. It should be understood that the interference range is typically larger than the transmission range. Conceptually, if the transmission range is represented as a circle around the first AP, the interference range can be represented by a larger circle which encircles both the transmission range and first AP. A station (e.g., second AP or wireless user) that is outside the interference range of the first AP is defined as not interfering with any of the AP's communications with its associated mobile users.

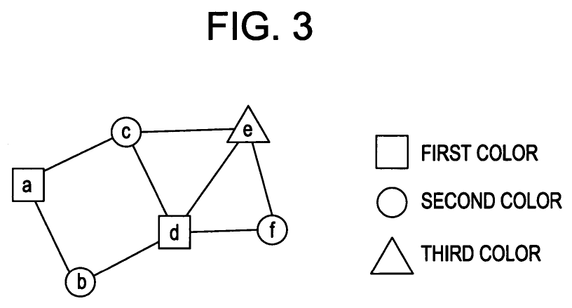

More specifically, the interference range of an AP 2a, . . . 2n is a circular region around the AP having an interference range or radius R₁=R_{T}+R_{S}, where R_{T} denotes a distance of a wireless device u from an AP i (i.e., a transmission range radius), R_{S} denotes a distance of another wireless device w from u (w may be a wireless device associated with a different AP and R_{S} may be viewed as a “sensing range” radius where a user may sense a signal sent from an AP but not be able to properly decode it, etc.), and the distance between any pair of interfering APs is at most 2·R_{T}+R_{S}. In a further embodiment of the present invention, these interference relationships can be represented by an interference graph, G(V, E), defined by a set V of APs and a set of edges E between every pair of APs, u, v ε V that are at most 2·R_{T}+R_{S} apart, i.e., d(u, v)≦2·R_{T}+R_{S}. An example of an interference graph G(V, E) of a WLAN with six APs is depicted in FIG. 3. To aid a network engineer or the like responsible for analyzing these interference graphs, the graphs may be colored where each color represents a group of APs which do not interfere with one another (i.e., non-interfering APs). Similarly, a group of non-interfering APs may be indicated by using a geometric shape (e.g., the squares, circles and triangle shown in FIG. 3).

Thus, by identifying groups of non-interfering APs and then only allowing (in some order) each group of non-interfering APs to transmit during a CFP slot, the overlapping cell problem is minimized or eliminated.

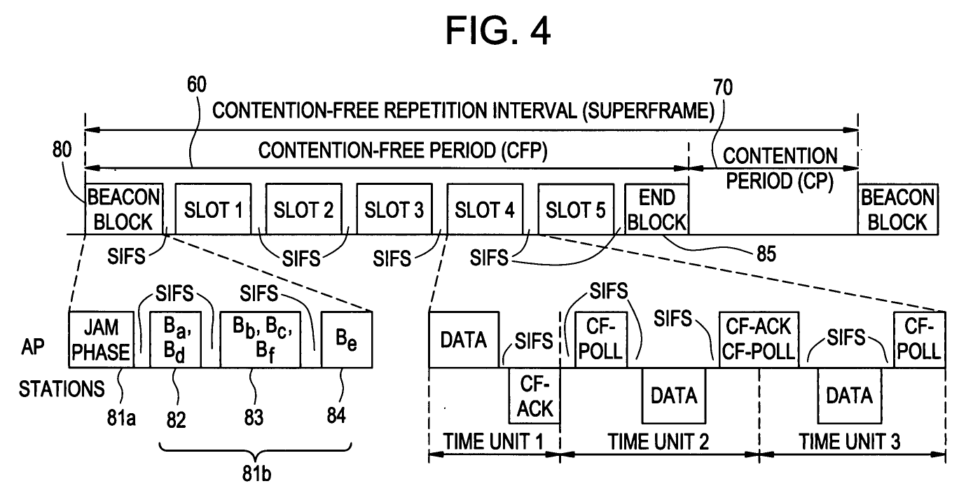

Backtracking somewhat, prior to allowing each set or group of non-interfering APs to transmit, beacon messages are sent to silence all APs and their associated users at the beginning of a CFP. Generally, this can be thought of as an initialization step or the like. In more detail, in the 802.11 standard each CFP starts with a beacon message and ends with a CF-end message. For example, FIG. 4 depicts a CFP 60. The CFP 60 begins with a beacon block 80 comprised of a jamming block or phase 81a and a transmission phase 81b made up of one or more beacon transmission blocks or messages 82-84. The CFP 60 ends with a CF-end end message 85. For simplicity's sake, only the beacon block 80 will be described, though it should be understood that the end block 85 is similar in nature.

In one embodiment of the present invention, controller 4 is operable to control the transmission of instructions along pathways 4a, . . . 4n to APs 2a, . . . 2n (see FIG. 1) to initiate the beginning of beacon block 80. The beacon block 80 begins with the jamming phase 81a which is used to silence the associated users of APs 2a, . . . 2n for a time period (referred to as an Extended Interframe Space (EIFS) time period) that is long enough to ensure that no associated user is, or remains, transmitting. That is, during the jamming phase 81a, those users which are not transmitting are prevented from transmitting while those users that are transmitting cease their transmission before the end of the EIFS time period.

After jamming phase 81a ends, the beacon transmission phase 81b begins. In the beacon transmission phase, only non-interfering APs are permitted to transmit beacon messages 82-84 of their own in a way that avoids collisions among beacon messages. The beacon messages 82-84 are transmitted by respective ones of APs 2a, . . . 2n to associated users in order to prevent these users from transmitting prior to the beginning of CFP 60.

In greater detail, assume, for example, that the beacon block 80 starts at a time t₀. Any Request to Send (RTS) messages that originate before t₀ and whose data and acknowledgement (ACK) transmissions are supposed to end after time t₀ are ignored by the APs. Thus, at time t₀ when data or ACK messages are transmitted, the only possible transmissions are RTS messages. At time t₀, all the APs start to jam the channel for a period longer than RTS_TIME, where RTS_TIME is the time required for sending RTS messages at the lowest bit rate. As a result, all mobile users, including those that transmitted RTS messages at time t₀, sense the jammed signal and set their Network Allocation Vector (NAV) to EIFS. At the end of the jamming phase 81a, APs send their beacon messages in the beacon transmission phase 81b. Because beacon messages from two interfering APs may collide, a controller, such as controller 4 in FIG. 1, may be operable to control APs 2a, . . . 2n by transmitting instructions to APs 2a, . . . 2n whereby the beacon transmissions of APs are synchronized such that no two adjacent APs in an interference graph are allowed to send their beacon messages substantially simultaneously. To reduce the overhead of a beacon block, AP beacon messages should be sent as quickly as possible. This beacon “synchronization” problem may be mapped to a graph coloring problem. In one embodiment of the present invention, one such graph coloring problem seeks to find the minimal number of colors that are needed to color an interference graph, such that all nodes (e.g., APs) with the same color send their beacon messages substantially simultaneously (i.e., non-interfering APs send their beacon messages substantially simultaneously). The details of how the minimal number of colors is determined is beyond the scope of this application. One such method is disclosed in co-pending U.S. patent application Ser. No. ______ , the disclosure of which is incorporated by reference herein.

Having discussed the beacon block aspects of the present invention, the discussion which follows continues with a discussion of a slotted CFP 6 or 60 and CP 7 or 70.

Recall it is only during certain slots of CFP 6 that non-interfering access points (and their associated users) are allowed to transmit data. In one embodiment of the present invention, after the end of the CFP 6, the controller 4 is operable to allow all APs 2a, . . . 2n (i.e., both interfering and non-interfering) to transmit during the CP 7. Said another way, the controller 4 allows non-interfering APs to transmit in a PCF mode during CFP 6. At the end of the CFP 6, the controller 4 allows all the APs to transmit in a DCF mode during CP 7.

The ability to allow only certain APs to transmit during a given slot of a CFP also helps to minimize or eliminate the hidden node problem discussed above. As indicated above, the controller 4 is operable to allow only non-interfering APs to transmit during a given slot. Because each of these APs are associated with a given set of users 3, only those users 3 which are associated with the non-interfering APs are allowed to transmit during a given slot as well. The controller 4 is operable to control each AP to ensure that all of the non-interfering APs permitted to transmit during a given slot begin and end their transmissions within the time period associated with the slot to thereby ensure that all of the associated users 3 begin and end their transmissions within the same time period as well. This solves the hidden node (a.k.a. hidden user) problem.

As was indicated briefly above, a CFP can be broken into a number of slots. In general, controller 4 allocates slots to APs in such a way that no two interfering APs are assigned to the same slot and in a manner that maximiizes network throughput while ensuring inter-AP fairness. The following is a more detailed discussion of one example of how slots may be allocated to one or more APs.

In one embodiment of the invention, the controller 4 is operable to divide the CFP 6 into one or more slots and then assign one or more of the so-divided slots to an AP based on the number of users associated with the AP. It should be understood that the assignment of slots based on the number of users associated with an AP is only one slot-assignment rationale. Others may be employed as appropriate to a specific network.

Conceptually, breaking a CFP into slots can be thought of as a way to ensure that each AP has at least one slot during which it can transmit without the fear of running into hidden node or overlapping cell problems. However, it may be desirable to allow some APs to transmit for more than one slot. How many slots to assign to each AP (i.e., how long each AP is allowed to transmit) is up to a given network administrator, design engineer, etc.

Many different rationales may be used to answer the question: How many slots should be assigned to a given AP? One such rationale is to assign or allocate slots to APs based on the number of users associated with each AP, e.g., more users equates to more allocated slots and vice-versa. This is one “fairness” standard.

In a further embodiment of the present invention, controller 4 is operable to determine a lower bound of slot-to-user ratios associated with all of the APs. The slot-to-user ratio is a value that provides an indication of the number of slots that have previously been assigned to an AP with a given number of users.

In yet another embodiment of the present invention, the controller 4 is operable to assign so-divided slots to APs in order to maximize a lower bound of the slot-to-user ratios.

At the risk of being somewhat repetitious, in this embodiment, each of the APs has a slot-to-user ratio associated with it. This ratio represents the number of slots allocated to an AP divided by the number of users associated with that AP. In order to ensure that slots are fairly assigned to each AP (fairness), the present invention makes use of these slot-to-user ratios. To do so, after slots have been initially assigned to APs, controller 4 iteratively determines a lower bound for all of the slot-to-user ratios. Once this lower bound has been identified, controller 4 attempts to re-assign slots in order to maximize this lower bound. This process may proceed iteratively until the lower bound is maximized. By so doing, the present invention seeks to assign as many slots to each AP as possible, giving each AP the opportunity to transmit in proportion to the number of users associated with the AP. This prevents an AP which has many users from being assigned too few slots and vice versa; an AP with too few users being assigned too many slots.

Regardless of the slot-to-user ratio, it should be understood that the present invention envisions a controller 4 which assigns at least one so-divided slot to each AP 2a, . . . 2n.

Before going further it should also be understood that after a CFP is broken up into slots, the slots may be allocated to sets of non-interfering APs in any number of ways to achieve a network defined, level of fairness. The example given above, and discussed below, uses as its objective the assignment of slots based on maximizing a lower bound of a slot-to-user ratio to achieve a certain approximate level of fairness. Other levels of fairness may be more desirable depending on a specific network's design objectives. Nonetheless, such networks may still make use of the principles of the present invention.

It can be said then that the present invention may be used to provide a relative level of fairness (i.e., a wide range of fairness levels) from none at all to a high level of fairness.

Continuing, having presented one description of however slots may be assigned to APs, the following is a more detailed description of how slots may be assigned to APs.

In a further embodiment of the present invention, each CFP is divided into R slots enumerated from 1 to R. The term Sᵥ denotes a set of slots that are assigned to an AP denoted as v, and rᵥ, the number of slots in Sᵥ. A slot assignment factor, S={Sᵥ₁, Sᵥ₂, . . S_{v|v|}}, can be defined for the sets Sᵥᵢ for every AP vᵢ ε V. A slot assignment is termed feasible if for-every AP, v, Sᵥ ⊂[1. . . R] and any pair of adjacent nodes in an interference graph G(V, E) that uses the same frequency does not have a common slot, i.e., for every (u, v)ε E it follows that Sᵤ∩Sᵥ=0. For obtaining both inter-AP fairness and high throughput, a feasible slot assignment S is optimal if it maximizes a minimum-slot-to-user ratio (i.e., lower bound) defined by

$$ρ = {min}_{v ∈ V} \frac{{r}_{v}}{{m}_{v}}$$

where mᵥ is the number of users associated with AP, v.

In yet a further embodiment of the present invention, one optimal slot assignment scheme is an NP-hard problem. Such a problem may be solved in a number of ways, one of which is described in co-pending patent application Ser. No. ______ the disclosure of which is incorporated by reference herein.

A full discussion of the assignment techniques set forth in co-pending patent application Ser. No. ______ is beyond the scope of the present application. Nonetheless, a brief discussion may aid the reader's understanding of the present invention. In general, the assignment techniques disclosed in co-pending patent application Ser. No. ______ produce slot assignments that are based on maximizing a lower bound of a slot-to-user ratio. It should be understood that the techniques in co-pending patent application Ser. No. ______ may be modified, or other techniques may be used which are not a part of co-pending patent application Ser. No. ______ in order to maximize a lower bound of a slot-to-user ratio. Regardless of the technique used, the output of any technique should be an appropriate slot-to-user ratio.

Continuing, the exemplary technique disclosed in co-pending patent application Ser. No. ______ can be broken down into two parts. In the first part, a coloring algorithm is supplied with interference graphs of the form G(V, E), and a number of colors rᵥ, required by every node v ε V in order to generate feasible slot assignments using a minimum number of colors, designated K. In another embodiment of the present invention, if a supplied interference graph G(V, E) comprises a unit disk graph, the coloring algorithm works as a 3-approximation algorithm, meaning that an optimal coloring solution needs at least K/3 colors.

The second part of the assignment technique disclosed in co-pending patent application Ser. No. ______ involves a binary search to maximize the minimum slot-to-user ratio ρ which requires no more than R slots. It iteratively selects a ratio ρ and sets the requirement of each node v ε V to rᵥ=┌ρ·mᵥ┐ colors. In addition, the assignment techniques disclosed in co-pending patent application Ser. No. ______ make use of the coloring algorithm to check whether or not there is a feasible slot assignment with R slots (colors). Based on the result, the assignment algorithm picks a lower or higher value for the ratio ρ until it quickly converges to an optimal ratio ρ.

In a further embodiment of the present invention, a slot assignment is feasible only if all the slots/colors allocated to an AP belong to the same frequency (i.e., the one assigned to the AP; the 802.11 Standard allows the use of three non-overlapping frequencies F for reducing interference and increasing network throughput) but have different slots/colors at any two APs that share the same frequency. In other words two adjacent APs have a disjoint set of frequency/color (F,C) pairs.

In systems according to the present invention, each AP needs to maximize its bandwidth while providing a fair level of service to its associated RT and NRT users. For ensuring intra-AP fairness, each AP employs an admission control mechanism that enforces a given fairness criteria. For instance, consider an AP v that has rᵥ slots and is associated with mᵤ users, where mᵥ^{RT} of them are RT-users and let Δ be the number of time units in every slot. An admission control mechanism provided by the present invention approves new RT-session requests only while an aggregated flow allocated for RT-users does not exceed a threshold of

$${H}_{v} = c \cdot \frac{{m}_{v}^{RT}}{{m}_{v}} \cdot {r}_{v} \cdot Δ ,$$

for a given configuration parameter c and a requirement that Hᵥ<rᵥΔ. Such an admission control balances the probability of success of RT-session requests versus the average flow associated with each NRT-user.

An RT-user may initiate an RT-session by sending a request to its AP during the CP. If the AP approves the request, then it allocates a time unit to this user and adds the user's address to its polling list. During a CFP, an AP first polls all RT-users with active RT-sessions and in the remaining time in its slot it polls its NRT-users. Because Hᵥ is smaller than the time units available to AP v, i.e., rᵥ·Δ, every RT-user engaged in an active RT-session is either polled or receives data at each superframe. For ensuring intra-AP fairness, each AP employs a sliding “window” to determine the next NRT-user to poll at time t Each AP records the number of successfully served messages (either sent or received) by each NRT-user during a time period of [t−T, t], for a sliding window of size T. The next NRT-user that may be polled is the one which has the minimal number of served messages during that time period. It should be noted that intra-AP fairness may also be improved by increasing the size of the sliding window, T.

The above outlined polling mechanism may generate a number of unsuccessful polling attempts. In practice, NRT-stations do not always have data (e.g., packets) to send. Polling these stations will result in a decrease in system utilization. In a further embodiment of the present invention, the number of unsuccessful polling attempts may be reduced based on the following observations. Most traffic is from APs 2a, . . . 2n to mobile-users 3, conducting web browsing and email. Moreover, most packets involved in polling originate as a response to a receive message. For instance, TCP protocol based APs send “acknowledgments” after data is received and shift a sliding window upon reception of acknowledgments. In the present invention, each AP polls a user after sending it a packet. The user uses a CP for sending or initiating sessions or for resuming operation. Because the DCF mode may starve users located far from an AP, these users may not be able to send session request messages. This problem may be solved by polling, at a low rate, users that have not participated in an active session in a long time, or by using the priority mechanism of the 802.11-E proposal.

To provide a fairness guarantee, the mobility of users 3 must also be considered. Such mobility raises two main challenges. The first challenge is to support RT-sessions as users involved in RT-sessions change their association from one AP to another. In such a case, if a new AP is already supporting a maximal number of RT-sessions, the RT-session of the newly associated user may be dropped so as to not violate a fairness criteria. In yet a further embodiment of the present invention, seamless “handoffs” are ensured by allowing a short violation of the fairness criteria and assigning needed resources for the ongoing session. This violation ends as soon as one of the RT-sessions of an associated AP is terminated.

The second challenge is to change the number of slots that have been assigned as users change APs. As a result of the changing numbers of users associated with every AP, the slot assignment technique may violate inter-AP fairness. To offset this, the controller 4 is operable to periodically recalculate current slot-to-users ratios and compare them to best possible ratios. If the gap between the two ratios is significant, then the slot assignment is modified.

The discussion above has sought to set forth some examples of how the present invention solves the hidden node and overlapping cell problems while ensuring a relative level of fairness and QoS levels. Other examples and/or modifications may be envisioned that fall within the scope of the present invention as defined by the claims which follow.

1. A method for providing a relative level of fairness and Quality of Service (QoS) in a wireless local area network (WLAN) network comprising:
identifying a set of non-interfering access points;
allowing only the identified set of non-interfering access points to transmit during a Contention-Free Period (CFP) slot; and
allowing all access points to transmit after the end of the CFP.

2. The method as in claim 1 further comprising dividing the CFP into one or more slots.

3. The method as in claim 2 further comprising:
assigning one or more of the so divided slots to an access point which is allowed to transmit based on the number of users associated with the access point.

4. The method as in claim 3 further comprising:
assigning the so divided slots to access points to maximize a lower bound of a slot-to-user ratio.

5. The method as in claim 2 further comprising:
assigning at least one so divided slot to each access point.

6. The method as in claim 1 further comprising controlling each access point making up the identified set of non-interfering access points to ensure each access point begins and ends a transmission during the CFP slot.

7. The method as in claim 1 further comprising:
transmitting an instruction to initiate transmission of one or more beacon messages to prevent users associated with access points from transmitting prior to the beginning of the CFP.

8. The method as in claim 7 further comprising:
transmitting an instruction to initiate transmission of one or more beacon messages such that no two adjacent APs in an interference graph may send beacon messages substantially simultaneously.

9. A system for providing a level of fairness and Quality of Service (QoS) in a WLAN comprising:
a controller operable to;
identify a set of non-interfering access points;
allow only the identified set of non-interfering access points to transmit during a Contention-Free Period (CFP) slot; and
allow all access points to transmit after the end of the CFP.

10. The system as in claim 9, wherein the controller is further operable to divide the CFP into one or more slots.

11. The system as in claim 10, wherein the controller is further operable to assign one or more of the so divided slots to an access point which is allowed to transmit based on the number of users associated with the access point.

12. The system as in claim 11, wherein the controller is further operable to:
assign the so divided slots to access points to maximize a lower bound of a slot-to-user ratio.

13. The system as in claim 10, wherein the controller is further operable to assign at least one so divided slot to each access point.

14. The system as in claim 8 wherein the controller is further operable to control each access point making up the identified set of non-interfering access points to ensure each access point begins and ends a transmission during the CFP slot.

15. The system as in claim 9, wherein the controller is further operable to transmit an instruction to initiate transmission of one or more beacon block messages to prevent users associated with access points from transmitting prior to the beginning of the CFP.

16. The system as in claim 15, wherein the controller is further operable to transmit an instruction to initiate transmission of one or more beacon messages such that no two adjacent APs in an interference graph may send beacon messages substantially simultaneously.

17. The system as in claim 9 further comprising one or more sets of non-interfering access points, each set of access points operable to:
transmit during at least one Contention-Free Period (CFP) slot; and
transmit after the end of the CFP.

18. A system for providing a relative level of fairness and Quality of Service (QoS) in a wireless local area network (WLAN) network comprising:
means for identifying a set of non-interfering access points;
means for allowing only the identified set of non-interfering access points to transmit during a Contention-Free Period (CFP) slot; and
means for allowing all access points to transmit after the end of the CFP.

19. The system as in claim 18 further comprising means for dividing the CFP into one or more slots.

20. The system as in claim 19 further comprising:
means for assigning one or more of the so divided slots to an access point which is allowed to transmit based on the number of users associated with the access point.

21. The system as in claim 20 further comprising:
means for assigning the so divided slots to access points to maximize a lower bound of a slot-to-user ratio.

22. The system as in claim 19 further comprising:
means for assigning at least one so divided slot to each access point.

23. The system as in claim 18 further comprising means for controlling each access point making up the identified set of non-interfering access points to ensure each access point begins and ends a transmission during the CFP slot.

24. The system as in claim 18 further comprising:
means for transmitting an instruction to initiate transmission of one or more beacon messages to prevent users associated with access points from transmitting prior to the beginning of the CFP.

25. The system as in claim 24 further comprising:
means for transmitting an instruction to initiate transmission of one or more beacon messages such that no two adjacent APs in an interference graph may send beacon messages substantially simultaneously.
